(19) United States
(12) Patent Application Publication
(10) Pub. No.: US 2014/0275286 A1
(43) Pub. Date: Sep. 18, 2014

(54) RHEOLOGICAL MOLECULAR REBAR

(71) Applicant: Molecular Rebar Design, LLC, Austin, TX (US)

(72) Inventors: Clive P. Bosnyak, Dripping Springs, TX (US); Kurt W. Swogger, Austin, TX (US)

(73) Assignee: Molecular Rebar Design, LLC, Austin, TX (US)

(21) Appl. No.: 14/209,044

(22) Filed: Mar. 13, 2014

Related U.S. Application Data
(60) Provisional application No. 61/799,525, filed on Mar. 15, 2013.
(60) Provisional application No. 61/884,872, filed on Sep. 30, 2013.

(51) Int. Cl. C01B 31/02

(52) U.S. Cl. CPC C01B 31/022
USPC 514/769; 423/447.2; 252/62.2; 252/502; 252/182.1; 106/286.8

(57) ABSTRACT

In various embodiments a carbon nanotube molecular rebar formulation comprising a specific composition is disclosed. The composition comprises discrete carbon nanotubes that have at least a portion of the carbon nanotubes with a number average (ratio of number average contour length to end to end length) of greater than 1.1 and up to about 3. These discrete carbon nanotubes having the specified ratio of number average (tube contour length (TCL) to number average tube end-end length) ratio are not only discrete (separated) from one another, but are also controlled in their alignment such that processability and mechanical strength properties are both enhanced. Utility of the molecular rebar composition includes, but is not limited to improved composites, engineered materials, foams, sealants, coatings and adhesives, energy devices such as photovoltaics, batteries and capacitors, sensors and separation membranes.

### CROSS REFERENCE TO RELATED APPLICATIONS

This patent application claims priority to, and the benefit of, U.S. Provisional Patent Application No. 61/799,525 filed Mar. 15, 2013, and U.S. Provisional Patent Application No. 61/884,872 filed Sep. 30, 2013; the disclosures of which are incorporated herein by reference.

### STATEMENT REGARDING FEDERALLY SPONSORED RESEARCH

Not applicable

### BACKGROUND

Carbon nanotubes (“CNT”) in various forms have been widely written about and disclosed. They have been widely reported to have very high Young's modulus up to 1 Terapascal and provide significant improvements in composite materials stiffness when properly dispersed in a discrete manner and well adhered or bonded to the matrix. However, these carbon nanotubes, as made in the form of fibers or fibrils, are “clumped” together due to the entangled nature of the fibers, making them less than ideal or even useful to their full potential. Separating these nanotubes into individual fibers and fibrils is now possible and these separated “discrete” (un-entangled) carbon nanotube fibers are useful in many applications, including reinforcement of other materials.

Of particular need is to be able to provide a concentrate of discrete carbon nanotubes, a master batch, wherein the end-user can choose a given medium to dilute the carbon nanotubes using conventional manufacturing processes such as melt compounding, solution spinning and the like. However, a very significant problem is that with inclusion of rigid carbon nanotubes, even at low concentrations, the melt viscosity of the composite can increase dramatically making it very difficult to fabricate or dilute with other medium such as polymers.

The Guth equation, equation 1, is commonly used to describe the increase in shear modulus, G, of a composite containing rod-shaped rigid fillers. The shear modulus increases with the aspect ratio (length to diameter ratio), f, of a rod shaped filler and the volume fraction, C.

G=G₀(1+0.67fC+1.62f²C²) Equation 1

Shear viscosity is defined as the shear modulus divided by the shear rate. For example, at master batch concentrations of 10% volume carbon nanotubes with an aspect ratio of 100 the shear modulus would be expected to be about 170 times larger than that of the matrix.

### SUMMARY

In one aspect the invention is a composition comprising discrete carbon nanotubes (“DCNT”) wherein at least a portion of discrete nanotubes has a ratio of number average value of ((tube contour length (T_{CL})):(tube end to end length (T_{EE}))) of from about 1.1 to about 3, preferably from about 1.1 to about 2.8, more preferably from about 1.1 to about 2.4, most preferably from about 1.1 to about 2 and especially form about 1.2 to about 2. Preferably from about 10 to about 90% by volume, more preferably from about 10 to about 70%, and especially from about 10 to about 50% of the discrete carbon nanotubes tubes have a contour length (T_{CL})):(tube end to end length (T_{EE}))) of from about 1.1 to about 3.

Another aspect of the invention is a composition comprising discrete carbon nanotubes wherein at least a portion of discrete nanotubes has a number average tube contour length (T_{CL}) of at least 10% greater than, and up to about 300% of, a number average tube end to end length (T_{EE}), wherein the number average T_{CL} and T_{EE} are obtained from the same batch of discrete carbon nanotubes.

In another aspect, in a composition comprising discrete carbon nanotubes having an average actual aspect ratio, the improvement comprising at least about 5% (volume) of the discrete carbon nanotubes having an apparent aspect ratio from about 50% to about 99% of the average actual aspect ratio of the discrete carbon nanotubes. The apparent aspect ratio can be from a low of about 60% or 70%, to as high as about 80%, 90%, about 99% of the actual aspect ratio.

The composition can have at least about 10% (volume), preferably 20%, more preferably 50%, most preferably 75%, and especially 95%, of the discrete carbon nanotubes that have an apparent aspect ratio from about 50% to about 99% of the actual aspect ratio of the discrete carbon nanotubes.

The apparent aspect ratio can be measured under liquid or melt shear conditions, then quench cooled at a specified rate, and the actual aspect ratio is measured after relaxation at room temperature (25° C.).

Another aspect of the invention is in a composition comprising discrete carbon nanotubes having a number average contour length T_{CL}, the improvement comprising at least about 5% (volume) of the discrete carbon nanotubes have a number average end-to-end tube length T_{EE} low value from about 50%, 60%, or 70% to a high value of about 80%, 90%, or 99% of the number average T_{CL}.

The composition can have at least about 10% (volume), preferably 20%, more preferably 50%, most preferably 75%, and especially 95%, of the discrete carbon nanotubes have a number average T_{EE} from about 50% to about 99% of the number average T_{CL} of the discrete carbon nanotubes.

The number average T_{EE} can be measured under liquid or melt shear conditions, then quench cooled at a specified rate, and the number average T_{CL} is measured after relaxation at room temperature (25° C.).

The composition comprising the discrete nanotubes can further comprise other forms of carbon (e.g., graphene or carbon black), or silicon.

The at least a portion of discrete nanotubes can have a number average value of (the ratio of discrete T_{CL}, to T_{EE}) of about 1.1 to as high as about 3, is greater than 5% by number, preferably greater than 20% by number and most preferably greater than 50% by number of tubes.

The composition comprising the discrete nanotubes wherein upon dilution of the composition by 50%, the effective aspect ratio of the tubes number average value of the discrete tube contour length to end to end distance increases by at least 10%.

The composition described herein can further comprise fibers, platelets, or spherical particles, or combinations thereof.

Processes to make the discrete carbon nanotubes are also described herein. Other process steps can be performed with the processes described herein. These additional (and optional) steps can be selected from adding the DCNT to a material to react with the oxidized CNT, adding surfactants, and adding other fillers. Any of these steps can be performed in additional to those recited, or they can all be performed simultaneously or sequentially.

Another embodiment of the invention comprises these unique rheological carbon nanotubes in energy storage and energy collective applications, such as, but not limited to batteries, capacitors and photovoltaics. Specifically, a fluid comprising rheological discrete carbon nanotubes and surfactant is disclosed, wherein a volume fraction, V, of the carbon nanotubes in the fluid is in the range determined from the equation 0.6≦V*(L/D)≦6, wherein L is the average length of the carbon nanotube in nanometers, and D is the average diameter of the carbon nanotube in nanometers. Put another way, the value of X, from the equation X=V*(L/D), can be from a lower value of about 0.6 or more, or preferably about 0.8 or more; to a higher value of X of about 6 or less, preferably about 3 or less, more preferably about 2 or less, most preferably about 1.4 or less. The higher and lower limits just disclosed for the value of X can be combined in any combination, but the most preferred combination is when the value of X is from about 0.8 to about 1.4. The fluid can be polar or non-polar, polymeric, organic, inorganic or aqueous in nature. Organic fluids can be, but are not limited to, alkanes, aromatics, alcohols, ethers, esters, ketones, amides, nitriles and amines. Polymers may be amorphous or crystalline, and preferably with crystallinity less than 30% by weight of the polymer in the fluid state. Preferably, at least a portion, preferably from about 5 percent by weight to about 95 percent by weight, of the rheological discrete nanotubes has a ratio of number average value of ((tube contour length (TCL)):(tube end to end length (TEE))) of from about 1.1 to about 3, preferably from about 1.1 to about 2.8, more preferably from about 1.1 to about 2.4, most preferably from about 1.1 to about 2 and especially from about 1.2 to about 2.

One embodiment comprises a lead acid electroactive paste comprising the fluid comprising rheological discrete carbon nanotubes and surfactant. Preferred ratios of rheological DCNT:surfactant is 10:1 to 1:5, preferably 10:1 to 1:3, and more preferably 5:1 to 1:1. The lead acid electroactive paste further comprises lead oxide. Additional components of the electroactive paste could include lead, lead sulfate, barium sulfate, carbon black and lignin sulfonate.

Another embodiment comprises a lithium ion electroactive paste comprising the fluid comprising rheological discrete carbon nanotubes and surfactant. Preferred ratios of rheological DCNT:surfactant is 10:1 to 1:5, preferably 10:1 to 1:3, and more preferably 5:1 to 1:1. The lithium ion electroactive paste can comprise lithium containing compounds or elements that alloy with lithium to allow absorption and desorption of lithium ions. Examples of lithium containing compounds include lithium transition metal oxides or phosphates such as, but not limited to, lithium iron phosphate, lithium cobalt oxide, lithium manganese oxide, lithium manganese phosphate, lithium titanate, and lithium manganese nickel cobalt oxide. Elements that alloy with lithium are for example, but not limiting in scope, silicon, carbon, silicon carbon alloys, and tin. Additional components of the electroactive paste may comprise binders such as, but not limiting in scope to, polyvinylidene fluoride, sodium carboxymethylcellulose, polyacrylic acid, polyacrylonitrile, polyvinyl alcohol, polyvinyl alcohol copolymers and styrene-butadiene copolymers.

Another embodiment is an electrolyte comprising the fluid comprising rheological discrete carbon nanotubes. The electrolyte can comprise ionic species, such as, but not limited to lithium perchlorate, lithium tetrafluoroborate, lithium trifluoromethanesulfate, lithium bistrifluoromethanesulfonimide, lithium bisoxalatoborate, 1-ethyl-3-methylimidazolium bis(trifluoromethylsulfonyl)imide (EMI-TFSI), 1-butyl-3-methylimidazolium hexafluorophosphate, potassium hydroxide, and sodium hydroxide. The electrolyte can comprise ionic species in the concentration range by weight of the fluid from about 5 to 99.8%, preferably in the range from about 10 to about 70% and most preferably in the range from about 15 to about 50%. The electrolyte can further comprise polymer, preferably the polymer comprising an oxygen moiety, most preferably polyethylene oxide.

A yet further embodiment is photovoltaic photoactive paste comprising the fluid comprising rheological discrete carbon nanotubes and surfactant. Preferred ratios of rheological DCNT:surfactant is 10:1 to 1:5, preferably 10:1 to 1:3, and more preferably 5:1 to 1:1. The photoactive paste comprises photoactive compounds such as, but not limiting in scope to, titanium dioxide and tin oxide. The photoactive paste may further comprise photoactive materials physically or covalently bound to the discrete carbon nanotubes. The photoactive paste may further comprise a photoactive organic dye. The photoactive organic dye may also be bound to the surface of the carbon nanotubes. A preferred photoactive dye comprises Ruthenium.

In another application embodiment for energy storage and energy collective applications, such as, but not limited to batteries, capacitors and photovoltaics, the fluid comprising rheological discrete carbon nanotubes and surfactant further comprises carbon nanotubes with surfaces comprising oxygen moieties in the weight range of 0.5 to 8% by weight of the carbon nanotube. Although not limiting in scope, typical carbon nanotube surface functional groups comprising oxygen moieties are hydroxyl and carboxylate groups. The oxygen moieties can further comprise organic or inorganic moieties.

In another embodiment, the fluid comprising rheological discrete carbon nanotubes have a portion, preferably >70% by weight, more preferably >90% by weight, of discrete carbon nanotubes that are open ended and ion conducting. The composition can further comprise at least one polymer. The polymer is selected from the group consisting of vinyl polymers, preferably poly(styrene-butadiene), partially or fully hydrogenated poly(styrene butadiene) containing copolymers, functionalized poly(styrene butadiene) copolymers such as carboxylated poly(styrene butadiene) and the like, poly(styrene-isoprene), poly(methacrylic acid), poly(acrylic acid), poly(vinylalcohols), and poly(vinylacetates), fluorinated polymers, preferably poly(vinylidine difluoride) and poly(vinylidene difluoride) copolymers, conductive polymers, preferably poly(acetylene), poly(phenylene), poly(pyrrole), and poly(acrylonitrile), polymers derived from natural sources, preferably alginates, polysaccharides, lignosulfonates, and cellulosic based materials, polyethers, polyolefins, polyesters, polyurethanes, epoxies and polyamides; homopolymers, graft, block or random co- or ter-polymers, and mixtures thereof.

In yet another embodiment of this invention, the fluid comprising rheological discrete carbon nanotubes fibers further comprises other non-tubular carbon structures such as, but not limited to graphene, graphene oxide, carbon black, and carbon fibers of diameter greater than about 100 nm. The weight ratio of rheological discrete carbon nanotubes of this invention to non-tubular carbon moieties is about 1:10 to about 10:1, respectively, preferably about 1:5 to about 5:1 and most preferably about 1:3 to about 3:1.

A yet further embodiment of this invention is where the fluid comprising rheological discrete carbon nanotubes further comprise additional inorganic structures comprising of elements of the groups two through fourteen of the Periodic Table of Elements. The fluid may be dried partially of fully to form a paste or dried film wherein the rheological carbon nanotubes are interspersed among the inorganic structures.

Another embodiment of the invention comprises these unique rheological carbon nanotubes in conductive ink applications.

In yet another embodiment of this invention the fluid comprising rheological discrete carbon nanotubes is oriented by such processes, but not limited to, ink jet printing, electrospinning, extrusion, fiber spinning, film stretching, injection molding, thermoforming, film or fiber stretching, microlayer extrusion or coextrusion, and force-spinning. The oriented fluid may then be treated further such that the rheologically discrete carbon nanotubes retain anisotropy, i.e., an orientation. Methods to treat the oriented fluid to retain orientation of the rheologically discrete carbon nanotubes include, but are not limited to, fast removal of fluid by heat, liquids or gases, chemical reaction, crystallization, and freezing.

A further embodiment of this invention is a medicament transfer system comprising rheological discrete carbon nanotubes further comprising a medicament. An example of a medicament transfer system is a transdermal patch wherein the medicament is transferred from the reservoir of the patch through the skin.

Another embodiment of the invention comprises these unique rheological carbon nanotubes in adhesives.

In various embodiments, the fluid can be used for the manufacture of carbon nanotube-containing structures including: fibers, films, coatings, cellular structures and layers.

### BRIEF DESCRIPTION OF THE DRAWINGS

FIG. 1 shows a pictorial of a discrete carbon nanotube MR illustrating the contour length and end to end distance.

FIG. 2 shows a pictorial of a two dimensional view as would be seen in a transmission electron micrograph of a slice of a three dimensional representation of discrete carbon nanotubes MR of this invention.

FIG. 3 shows a plot of end to end length vs contour length for master batch of discrete carbon nanotubes made at RT (25° C.) with no effective mixing time.

FIG. 4 shows a plot of end to end length vs contour length for master batch of discrete carbon nanotubes made at 140° C. with effective mixing time of 265 minutes.

FIG. 5 shows a plot of end to end length vs contour length for master batch of discrete carbon nanotubes made at 150° C. with effective mixing time of 165 minutes.

FIG. 6 shows a plot of end to end length vs contour length for master batch of discrete carbon nanotubes made at 160° C. with effective mixing time of 97 minutes.

FIG. 7 shows effective aspect ratio from DMA.

### DETAILED DESCRIPTION

In the following description, certain details are set forth such as specific quantities, sizes, etc. so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 3rd Edition, 2009. Definitions and/or interpretations should not be incorporated from other patent applications, patents, or publications, related or not, unless specifically stated in this specification.

During the process of making discrete or exfoliated carbon nanotubes (which can be single, double and multiwall configurations), the nanotubes are cut into segments with at least one open end and residual catalyst particles that are interior to the carbon nanotubes as received from the manufacturer are removed. This cutting of the tubes helps with exfoliation. The cutting of the tubes reduces the length of the tubes into carbon nanotube segments that are defined here as Molecular Rebar. Proper selection of the carbon nanotube feed stock related to catalyst particle type and distribution in the carbon nanotubes allows more control over the resulting individual tube lengths and overall tube length distribution. A preferred selection is where the internal catalyst sites are regularly spaced and where the catalyst is most efficient. The preferred aspect ratio (contour length to diameter ratio) is greater than about 25 and less than about 150 for a balance of viscosity and mechanical performance. The selection can be evaluated using electron microscopy and determination of the discrete or exfoliated tube distribution.

Molecular Rebar has oxidized species on the surface. Oxidized species include but not limited to carboxylates, hydroxyls and lactones. The oxidized species can react advantageously with species such as, but not limited to an acylchloride, epoxy, isocyanate, hydroxyl, amine group. This reaction may increase the bonding strength between the Molecular Rebar (MR) and the material chosen to form the composite. The Molecular Rebar may further comprise a dispersing agent, adhesively or covalently bonded to the Molecular rebar surface. As a result of the aforementioned, Molecular Rebar gives advantageous mechanical and ion or molecule transport properties when added to other materials compared to materials with no Molecular Rebar.

The discrete oxidized carbon nanotubes (or DCNT), alternatively termed exfoliated carbon nanotubes, of the present disclosure take advantage of properties such as electrical, thermal, physical and ion transport, offered by individual carbon nanotubes that are not apparent when the carbon nanotubes are aggregated into bundles.

Discrete oxidized carbon nanotubes, alternatively termed exfoliated carbon nanotubes, are obtained from as-made bundled carbon nanotubes by methods such as oxidation using a combination of concentrated sulfuric and nitric acids. The techniques disclosed in U.S. Ser. No. 13/164,456 (US 2012-0183770 A1) and U.S. Ser. No. 13/140,029 (US 2011-0294013 A1), the disclosures of which are incorporated herein by reference, are particularly useful in producing the discrete carbon nanotubes used in this invention. The bundled carbon nanotubes can be made from any known means such as, for example, chemical vapor deposition, laser ablation, and high pressure carbon monoxide synthesis. The bundled carbon nanotubes can be present in a variety of forms including, for example, soot, powder, fibers, and bucky paper. Furthermore, the bundled carbon nanotubes may be of any length, diameter, or chirality. Carbon nanotubes may be metallic, semi-metallic, semi-conducting, or non-metallic based on their chirality and number of walls. The discrete oxidized carbon nanotubes may include, for example, single-wall, double-wall carbon nanotubes, or multi-wall carbon nanotubes and combinations thereof. One of ordinary skill in the art will recognize that many of the specific aspects of this invention illustrated utilizing a particular type of carbon nanotube may be practiced equivalently within the spirit and scope of the disclosure utilizing other types of carbon nanotubes.

In particular for forming carbon nanotubes of this invention is the incorporation of a portion of structures called Stone-Wales defects which are the rearrangement of the six-membered rings of graphene into heptagon-pentagon pairs that fit within the hexagonal lattice of fused benzene rings constituting a wall of the carbon nanotubes. These Stone-Wales defects are useful to create sites of higher bond-strain energy for more facile oxidation of the graphene or carbon nanotube wall. These defects and other types of fused ring structures may also facilitate bending or curling along the length of the carbon nanotubes.

Stone-Wales defects are thought to be more prevalent at the end caps that allow higher degrees of curvature of the walls of carbon nanotubes. During oxidation the ends of the carbon nanotubes can be opened and also result in higher degrees of oxidation than along the walls. The higher degree of oxidation and hence higher polarity or hydrogen bonding at the ends of the tubes are thought useful to help increase the average contour length to end to end ratio where the tubes are present in less polar media such as natural rubber, cis-butadiene, styrene butadiene, isoprene, polystyrene, acrylonitrile butadiene. The ratio of the contour length to end to end distance can be advantageously controlled by the degree of thermodynamic interaction between the tubes and the medium. Surfactants can be usefully employed also to modify the thermodynamic interactions between the tubes and the medium of choice. Alternate means to influence the ratio of contour length to end to end ratio include the use of inorganic or ionic salts and organic containing functional groups that can be attached to or contacted with the tube surfaces.

General Process to Make Discrete Carbon Nanotubes (DCNT) or Molecular Rebar (MR)

As manufactured carbon nanotubes in the form of fibrous bundles can be obtained from different sources to make discrete carbon nanotubes. However, for the examples used herein, carbon nanotubes obtained from CNano, grade Flotube 9000 are used. CNano carbon nanotubes have about 5% wt. impurities of which about 4% (wt.) are metals, the majority of which is usually iron. The tube diameter distribution is about 13 nm (a later table herein lists other tube diameters of about 12.5 nm) by scanning electron microscopy (SEM). Carbon nanotube manufacturers can have higher % impurities and much broader and higher diameter tube distributions depending on manufacturing technique. Other tube manufacturers include Arkema, Nanocyl and SWeNT.

Discrete carbon nanotubes (Molecular Rebar or MR) can be made using a variety of process conditions, processes, and catalysts. Tube diameter and diameter distributions are determined by and characteristic of these conditions. Resulting tube length and length distributions from the MR process are also related, in part, to catalyst efficiency and process conditions as the catalyst incorporation amount, type and distribution help determine the ultimate length and length distribution of the discrete carbon nanotubes or MR. The MR process cuts the tubes preferentially at a catalyst site and the catalyst dissolves in the fluid medium. Preferably >70% by weight, more preferably >90% by weight, most preferably substantially all of the discrete carbon nanotubes tube ends are open ended after the MR conversion process.

Discrete CNT Formation

Nitric acid solution (greater than about 60 weight % concentration, preferably above 65% nitric acid concentration) can used to exfoliate the carbon nanotubes. Mixed acid systems (e.g., nitric and sulfuric) can also be used, but the single acid system improves subsequent filtration and control of oxidation rate, which in turn improves the operability of the process. The mixed acid system oxidizes the tubes desirably at room temperature whereas the nitric acid system, oxidizes at a desirable controllable rate at 70-90 degrees C.

### EXAMPLES

One illustrative process for making discrete carbon nanotubes follows: A 16 liter mixture of 1.2% CNT's (obtained from CNano, grade Flotube 9000) in 68% nitric acid, is pumped at 1.5 l/min. thru a 1000 watt Heilsher cell using a 34 mm sonitrode. The back pressure is 30 psi, the amplitude is set at 85% and the recorded watts are at 500-600. After all of the 16 liters are pumped through the cell, the CNT slurry is drained back into the Sonicator Tank and the process is repeated until the CNT's are exfoliated to the desired specification, for example as tested by optical microscopy and/or UV absorption. The number of times the material is processed or repeated is dependent on the amount of overall energy required to achieve the discrete tubes at high yield. This energy is in the range about 24000-40000 joules/gram of cnt. The required amount of energy will vary also by the degree of exfoliation required for a given application. The degree of oxidation can be measured by several tests such as O1s spectroscopy, energy dispersive X-ray and thermo-gravimetric analysis.

Quality of MR

The length of the tubes can be shortened by too long an exposure to the acid mixture, too high of a temperature of operation (>85° C.), too high of an amplitude of operation of the sonication unit, too high of a watts/cm² sonication and other factors. Oxidation type (acid, alcohol, ketones, and aldehydes) and their concentration distribution are affected by temperature, time, and sonication energy. The type of oxidation species desired varies depending on the formulation requirements of each type of application. For example, with rubbers a high degree of bonding is required between the rubber matrix and the tube surface. This requires high concentrations of carboxylic acid and hydroxyl groups on the tube surface.

Filtration

After successful exfoliation the slurry mix (no longer a CNT slurry but now a MR slurry) is transferred to the Filtration hold tank. This slurry is much more viscous than the original slurry indicative of much higher aspect ratio of the MR (aspect ratio in this example is about 60). The acid is removed using a filter and washed further with water.

Functionalized carbon nanotubes of the present disclosure generally refer to the chemical modification of any of the carbon nanotube types described hereinabove. Such modifications can involve the nanotube ends, sidewalls, or both. Chemical modifications may include, but are not limited to covalent bonding, ionic bonding, chemisorption, intercalation, surfactant interactions, polymer wrapping, cutting, solvation, and combinations thereof.

Materials comprising DCNT can have other additives such as other fibers (carbon, graphite, graphene, polymeric (polypropylene, polyethylene to name just a couple), and particulates (such as powders (carbon black), sand, diatomaceous earth, cellulose, colloids, agglomerates, antimicrobials and inorganic salts). Additives, such as but not limited to antioxidants, can be included and can further react or be completely inert with other components of the formulation. Fibrous additives can be surface active to react with surroundings.

The DCNT molecular rebar (MR) can comprise 0.01 to 90% by weight of the formulation, preferably 0.1 to 50%, more preferably 0.25 to 25% by weight of the formulation.

Based on application (such as reinforcing foam articles), 10% by weight or less of the rheological discrete carbon nanotubes of the formulation can comprise L/D of about 100 to 200 and about 30% or more of the rheological discrete carbon nanotubes of the formulation can comprise L/D of 40 to 80. The L/D of the discrete carbon nanotubes can be a unimodal distribution, or a multimodal distribution (such as a bimodal distribution). The multimodal distributions can have evenly distributed ranges of aspect ratios (such as 50% of one L/D range and about 50% of another L/D range). The distributions can also be asymmetrical—meaning that a relatively small percent of discrete nanotubes can have a specific L/D while a greater amount can comprise another aspect ratio distribution.

The adhesive strength of the compositions can be determined by using lap shear strength procedures and the Instron Tensile Testing Machine. The test is analogous to EN 1465. The specimen consists of two rigid substrates, for example aluminum sheets or copper sheets, bonded together by the composition in a lapped joint. This causes the two ends of the specimen to be offset from the vertical load line of the test. The composition is placed between two strips of material. The stress to failure on pulling the lapped specimen is recorded. Units are in MPa.

The improvement in flow processability of the compositions can be determined using a rheometer, for example, utilizing concentric cylinders with a well-defined geometry to measure a fluid's resistance to flow and determine its viscous behavior. While relative rotation of the outer cylinder causes the composition to flow, its resistance to deformation imposes a shear stress on the inner wall of the cup, measured in units of Pa. At a certain shear stress, fracture of the composition can occur resulting in poor homogeneity.

Lengths (nm)

| | Condition 1 | Condition 2 | Condition 3 |
|---|---|---|---|
| Mean | 424 | 487 | 721 |
| Standard Error | 25.3 | 34.9 | 50 |
| Median | 407 | 417.0 | 672 |
| Standard Deviation | 177 | 281 | 315 |
| Sample Variance | 31461 | 79108 | 99418 |
| Kurtosis | −0.83 | 1.5 | −0.02 |
| Skewness | 0.03 | 1.2 | 0.64 |
| Range | 650 | 1270.0 | 1364 |
| Minimum | 85 | 85.0 | 161 |
| Maximum | 735 | 1355 | 1525 |

Condition 1 is an example of a narrow distribution with low mean length. Condition 2 is an example of broad distribution with low mean length. Condition 3 is an example of high mean length and broad distribution.

To determine tube lengths, a sample of tubes is diluted in isopropyl alcohol and sonicated for 30 minutes. It is then deposited onto a silica wafer and images are taken at 15 kV and 20,000× magnification by SEM. Three images are taken at different locations. Utilizing the JEOL software (included with the SEM) a minimum of 2 lines are drawn across each image and the length of tubes that intersect these lines is measured.

Skewness is a measure of the asymmetry of a probability distribution. A positive value means the tail on the right side of the distribution histogram is longer than the left side and vice versa. Positive skewness is preferred which indicates means more tubes of long lengths. A value of zero means a relatively even distribution on both sides of the mean value. Kurtosis is the measure of the shape of the distribution curve and is generally relative to a normal distribution. Both skewness and kurtosis are unitless.

The following table shows representative values of discrete carbon nanotubes diameters:

TABLE 2
Diameter (unrelated to condition above)

| | |
|---|---|
| Mean diameter (nm*) | 12.5 |
| Median diameter (nm) | 11.5 |
| Kurtosis | 3.6 |
| Skewness | 1.8 |
| Calculated aspect ratio | 34 39 58 |
| (Conditions 1, 2, 3) | |
| (L/D) | |

*nm = nanometer

Another illustrative process for producing discrete carbon nanotubes follows: 3 liters of sulfuric acid (containing 97 percent sulfuric acid and 3 percent water), and 1 liter of concentrated nitric acid (containing 70 percent nitric acid and 30 percent water), are added into a 10 liter temperature controlled reaction vessel fitted with a sonicator and stirrer. 40 grams of non-discrete carbon nanotubes, grade Flowtube 9000 from CNano corporation, are loaded into the reactor vessel while stirring the acid mixture and the temperature maintained at 30° C. The sonicator power is set at 130-150 watts and the reaction is continued for 3 hours. After 3 hours, the viscous solution is transferred to a filter with a 5 micron filter mesh and much of the acid mixture removed by filtering using a 100 psi pressure. The filter cake is washed one time with about 4 liters of deionized water followed by 1 wash of about 4 liters of ammonium hydroxide solution at pH greater than 9 and then 2 more washes with 4 liters of deionized water. The resultant pH of the final wash is 4.5.

A small sample of the filter cake is dried in vacuum at 100° C. for 4 hours and a thermo gravimetric analysis taken. The amount of oxidized species on the fiber is 8 percent weight and the average aspect ratio as determined by scanning electron microscopy to be 60. The discrete carbon nanotubes (DCNT) in wet form are added to water to form a concentration by weight of 1 percent and the pH is adjusted to 9 using ammonium hydroxide. Sodium dodecylbenzene and sulfonic acid is added at a concentration of 1.5 times the mass of oxidized carbon nanotubes. The solution is sonicated while stirring until the DCNT are fully dispersed in the solution. Sufficient dispersion of individual tubes (discrete) is defined when the UV absorption at 500 nm is above 1.2 absorption units for a concentration of 2.5×10⁻⁵ g CNT/ml.

The table below summarizes the ratios of (number average tube contour length (CL)) to (number average end to end tube length (EE)) as a function of mixing conditions (time and temperature). Mixing is accomplished using a Haake batch mixer in 10-80 min⁻¹ RPM range. The summation of the number average ratios of (CL to EE) over the sample number size measured is also reported. “MB” is the abbreviation for master batch. As the data demonstrates, the ratio of Σ(CL)/n:Σ(EE)/n (first column) ranges from 1.26 to 1.42 for these experiments, showing that the ratio can be controlled through judicious use of mixing conditions. This means that for the discrete tubes in column 1, first row having Σ(CL)/n:Σ(EE)/n of 1.26, the T_{EE} length is an average of about 79.4% that of the T_{CL} length. Said another way, the tubes are bent, or doubled back on themselves, or curled, such that the end to end length is about 80% the length of the contour length (or length fully stretched). This means that the tubes can be processed in a liquid or melt environment more favorably and will have useful rheological properties—lower viscosity in the liquid or melt under shear conditions. However, in the solid relaxed state (such as in a reinforcement application), the tubes are also straighter and function more rigidly to better reinforce the matrix. The other column shows number average (of the ratio of (T_{CL}:T_{EE})).

TABLE 3

| Sample | $\frac{\frac{Σ ( CL )}{n}}{\frac{Σ ( EE )}{n}}$ | T_{EE} as % of T_{CL} from previous column | $\frac{Σ ( \frac{CL}{EE} )}{n}$ | T_{EE} as % of T_{CL} from previous column |
|---|---|---|---|---|
| MB @ 0 min./RT | 1.2592 | 79.4% | 1.2972 | 77% |
| MB @ 265 min./ | 1.4256 | 70.1% | 1.9006 | 52.6% |
| 140° C. | | | | |
| MB @ 146 min./ | 1.3173 | 75.9% | 1.6211 | 61.7% |
| 150° C. | | | | |
| MB @ 97 min./ | 1.3770 | 72.6% | 1.7385 | 57.5% |
| 160° C. | | | | |

Any of the aspects disclosed in this invention with discrete carbon nanotubes may also be modified within the spirit and scope of the disclosure to substitute other tubular nanostructures, including, for example, inorganic or mineral nanotubes. Inorganic or mineral nanotubes include, for example, silicon nanotubes, boron nitride nanotubes and carbon nanotubes having heteroatom substitution in the nanotube structure. The nanotubes may include or be associated with organic or inorganic elements such as, for example, carbon, silicon, boron and nitrogen. Association may be on the interior or exterior of the inorganic or mineral nanotubes via Van der Waals, ionic or covalent bonding to the nanotube surfaces.

1. A composition comprising discrete carbon nanotubes wherein at least a portion of discrete nanotubes has a ratio of number average value of ((tube contour length (T_{CL})):(tube end to end length (T_{EE}))) of from about 1.1 to about 3.

2. A composition comprising discrete carbon nanotubes wherein at least a portion of discrete nanotubes has a number average tube contour length (T_{CL}) of at least 10% greater than, and up to about 300% of, a number average tube end to end length (T_{EE}), wherein the number average T_{CL} and T_{EE} are obtained from the same batch of discrete carbon nanotubes.

3. In a composition comprising discrete carbon nanotubes having an average actual aspect ratio, the improvement comprising at least about 5% (volume) of the discrete carbon nanotubes having an apparent aspect ratio from about 50% to about 99% of the average actual aspect ratio of the discrete carbon nanotubes.

4. The composition of claim 3, wherein at least about 10% (volume) of the discrete carbon nanotubes have an apparent aspect ratio from about 50% to about 99% of the actual aspect ratio of the discrete carbon nanotubes.

5. The composition of claim 3 wherein the apparent aspect ratio is measured under liquid or melt shear conditions, then quench cooled at a specified rate, and the actual aspect ratio is measured after relaxation at room temperature (25° C.).

6. In a composition comprising discrete carbon nanotubes having a number average contour length T_{CL}, the improvement comprising at least about 5% (volume) of the discrete carbon nanotubes have a number average end-to-end tube length T_{EE} from about 50% to about 99% of the number average T_{CL}.

7. The composition of claim 6, wherein at least about 10% (volume) of the discrete carbon nanotubes have a number average T_{EE} from about 50% to about 99% of the number average T_{CL} of the discrete carbon nanotubes.

8. The composition of claim 6 wherein the number average T_{EE} is measured under liquid or melt shear conditions, then quench cooled at a specified rate, and the number average T_{CL} is measured after relaxation at room temperature (25° C.).

9. The composition of claim 1 wherein the discrete nanotubes further comprise other forms of carbon, or silicon.

10. The composition of claim 1 wherein the at least a portion of discrete nanotubes that have a number average value of (the ratio of discrete T_{CL} to T_{EE}) of about 1.1 to as high as about 3, is greater than 5% by number of tubes.

11. The composition of claim 1 wherein upon dilution by 50%, the effective aspect ratio of the tubes number average value of the discrete tube contour length to end to end distance increases by at least 10%.

12. The composition of claim 6 further comprising fibers, platelets, or spherical particles, or combinations thereof.

13. The composition of any of claims 1-3 in the form of a foam, a sealant, a coating and an adhesive.

14. The composition of any of claims 1-3 in the form of an energy device selected from the group consisting of photovoltaics, batteries and capacitors, sensors and separation membranes.

15. The composition of any of claims 1-3 in the form of layers in a microlayer extrusion or coextrusion.

16. The composition of any of claims 1-3 in the form of layers of a nanotube containing structure.
